(19) United States
(12) Patent Application Publication
(10) Pub. No.: US 2020/0309017 A1
(43) Pub. Date: Oct. 1, 2020

(54) A COOLING SYSTEM FOR A COMBUSTION ENGINE AND A FURTHER OBJECT

(71) Applicant: Scania CV AB, Södertälje (SE)

(72) Inventors: Zoltan KARDOS, Södertälje (SE); Ola HALL, Stockholm (SE); Mats EKMAN, Nykvarn (SE)

(21) Appl. No.: 16/099,704

(22) PCT Filed: May 11, 2017
(86) PCT No.: PCT/SE2017/050474

§ 371 Date: Nov. 8, 2018

(30) Foreign Application Priority Data
May 19, 2016 (SE) 1650678-4

(51) Int. Cl. F01P 7/16; F01P 3/20

(52) U.S. Cl. CPC F01P 7/165; F02B 29/0443; F01P 3/20

(57) ABSTRACT

A cooling system configured to cool a combustion engine (2) and at least one further object (18) in a vehicle (1) includes a main radiator (8), a main radiator bypass line (9) directing coolant past the main radiator (8), a first valve device (6) receiving coolant from a coolant line (5) and directing it to the main radiator line (7) and the main radiator bypass line (9), an auxiliary circuit (14) directing coolant to the further object (13, 28), a main radiator outlet line (7b) directing at least a part of the coolant leaving the main radiator (8) to the auxiliary circuit (14), and a second valve device (20) receiving coolant from the main radiator (11) and/or the main radiator bypass line (9) and directing it to the auxiliary circuit (14) and/or the engine inlet line (3). The auxiliary circuit (14) includes an auxiliary radiator (15) and an auxiliary radiator bypass line (17) directing coolant past the auxiliary radiator (15) which are arranged in an upstream position of the further object (13, 28) in the auxiliary circuit (14) and a bypass valve (18) configured to control the coolant flow through the auxiliary radiator bypass line (17).

### CROSS-REFERENCE TO RELATED APPLICATIONS

The present application is a 35 U.S.C. §§ 371 national phase conversion of PCT/SE2017/050474, filed May 11, 2017, which claims priority of Swedish Patent Application No. 1650678-4, filed May 19, 2016, the contents of which are incorporated by reference herein. The PCT International Application was published in the English language.

### BACKGROUND OF THE INVENTION AND PRIOR ART

The present invention relates to a cooling system for a combustion engine and for a further object.

A cooling system in a heavy vehicle is many times used to cool a combustion engine and at least one further object demanding a lower operating temperature than the combustion engine. The further object may be the working medium of a WHR system cooled in a condenser, charge air cooled in a charge air cooler, power electronics of a hybrid vehicle etc. In this case, it is necessary to create at least two different coolant temperature levels in the cooling system. Such a cooling system can be equipped with a main radiator and an auxiliary radiator cooling the coolant to a lower temperature than the main radiator. The coolant of the higher temperature is directed to the combustion engine and the coolant of the lower temperature is directed to the further object. During certain operating conditions, for example, when the cooling demand of the further object or the combustion engine varies rapidly, it is difficult to direct coolant at required temperature and flow rate to the combustion engine as well as to the further object in order to maintain their efficient operating temperatures. In this case, it is, for example, a risk that coolant of a too low temperature is directed to the combustion engine.

WO 2004/044512 shows a cooling system for cooling of a combustion engine and a number of further components in a vehicle. The cooling system comprises a first radiator and a second radiator. The first radiator receives coolant from the combustion engine. A partial coolant flow from the first radiator is directed to the combustion engine and a second partial coolant flow from the first radiator is directed to the second radiator. Thus, two partial flows are created of different temperatures which are directed to different components in the vehicle having different cooling demands.

### SUMMARY OF THE INVENTION

The object of the present invention is to provide a cooling system maintaining an efficient operating temperature of a combustion engine and a lower efficient operating temperature of a further object during substantially all operating conditions.

The above mentioned object is achieved by the cooling system according to the invention. During operating conditions when the combustion engine has a lower temperature than an efficient operating temperature, a first valve device directs a main part of the coolant flow to the main radiator bypass line and a small part of the coolant flow to the main radiator. A second valve device directs the coolant from the main radiator bypass line to the engine without cooling the engine. Due to this measure, the temperature of the combustion engine will rise rapidly to an efficient operating temperature. The smaller part of the coolant flow is usually cooled in the main radiator to a temperature low enough to cool the further object to an efficient operating temperature. In this case, it is not necessary to use the auxiliary radiator and the coolant is directed from the main radiator to the further object via the auxiliary radiator bypass line. In case, the coolant leaving the main radiator has a too low temperature, it is possible to control the second valve device such that it directs a suitable quantity of uncooled coolant from the main radiator bypass line to the auxiliary circuit, where it is mixed with coolant from the main radiator. With a suitable mixture of the coolants of different temperatures, it is possible to direct coolant of a suitable temperature to the further object, via the auxiliary radiator bypass line, at which the further object is cooled to an efficient operating temperature.

During operating conditions when the combustion engine has a higher temperature than an efficient operating temperature, the first valve device directs the entire coolant flow to the main radiator. The second valve device directs a suitable part of the coolant flow from the main radiator to the engine inlet line in order to cool the combustion engine to an efficient operating temperature. In this case, it is not always possible to cool the large coolant flow through the main radiator to a temperature low enough to cool the further object to an efficient operating temperature. In such a case, the valve is configured to close the auxiliary radiator bypass line such that the coolant from the main radiator also flows through the auxiliary radiator before it enters the further object. In such a manner, it is usually always possible to cool the further object to an efficient operating temperature. Consequently, the cooling system is able to maintain an efficient operating temperature of a combustion engine and a lower efficient operating temperature of a further object during substantially all operating conditions.

According to an embodiment of the invention, the cooling system comprises a control unit configured to receive information about a number of operating parameters and to control the first valve device, the second valve device and the bypass valve in view of information about the operating parameter. The control unit may estimate the cooling demands of the combustion engine and the further object by means of the operating parameter and estimate a suitable coolant temperature and coolant flow rate to the combustion engine as well as to the further object at which they maintain an efficient operating temperature.

According to an embodiment of the invention, one of the operating parameters is related to the temperature of the combustion engine. In this case, the control unit may receive information from a temperature sensor sensing the temperature of the coolant leaving the combustion engine. Alternatively, a temperature sensor may sense the temperature of a suitable part of the combustion engine. One operating parameter may be related to the temperature of the further object. In this case, the control unit may receive information from a temperature sensor sensing the temperature of the coolant leaving the further object. Alternatively, a temperature sensor may sense the temperature of a suitable part of the further object. In order to control the temperature of the coolant, it is suitable to have a temperature sensor sensing the temperature of the coolant entering the further object and a temperature sensor sensing the temperature of the coolant leaving the further object. The control unit may of course receive information from further operating parameters.

According to an embodiment of the invention, the first valve device is a three way valve. The three way valve may comprises one inlet opening and two outlet openings. The three way valve receives, via the inlet opening, a coolant flow from a line of the cooling system and directs a first part of it, via a first outlet opening, to the radiator line and a second part of it, via the second outlet opening, to the radiator bypass line. In this case, the first valve device is designed as a single valve. Preferably, the first valve device is adjustable in a stepless manner. In this case, it is possible to vary the coolant flow rate to the radiator line and the radiator bypass line with a high accuracy. Alternatively, the first valve device is designed as two two way valves wherein a first two way valve is arranged in the radiator inlet line and a second two way valve is arranged in the radiator bypass line.

According to an embodiment of the invention, the second valve device is a three way valve. The three way valve receives a coolant flow from the radiator bypass line and directs a part of it to the auxiliary circuit and a remaining part of it to the engine inlet line. It may also direct coolant from the main radiator to the engine inlet line. In this case, the second valve device is designed as a single valve. Preferably, the second valve device is adjustable in a stepless manner. In this case, it is possible to adjust the coolant flow rate to the auxiliary circuit and the engine inlet line with a high accuracy. Alternatively, the second valve device is designed as two two way valves wherein a first two way valve is arranged in a main radiator outlet line and a second two way valve is arranged in the engine inlet line.

According to an embodiment of the invention, the first valve device and/or the second valve device are designed to conduct small coolant flow rates with a higher accuracy than larger coolant flow rates. During operating conditions when the coolant has a relatively low temperature, the first valve device directs a small coolant flow rate to the main radiator. This small coolant flow rate may be mixed with a small warm coolant flow rate from the radiator bypass line by the second valve device before the mixture is directed to the further object. In order to obtain a required coolant temperature of the mixture with a high accuracy, it is suitable to use a first valve device and a second valve device with the above mentioned design. The first valve devices may comprise a valve member movably arranged within a movement range having an extent between a first end position in which it directs no coolant flow to the main radiator and a second end position in which it directs the entire coolant flow to the main radiator. The movement range for the valve member at which it directs small coolant flows to the radiator line is greater than the movement range for the valve member at which it directs larger coolant flows to the radiator. The second valve device may have a corresponding design as the first valve device.

According to an embodiment of the invention, the bypass valve is a two way valve arranged in the auxiliary radiator bypass line. The flow resistance through the auxiliary radiator bypass line is considerably lower than the flow resistance through the auxiliary radiator. Thus, when the two way valve is open, the main part of the coolant will be directed through the auxiliary radiator bypass line and a smaller part of the coolant through the auxiliary radiator. The bypass valve may be a stop-flow valve (e.g. solenoid valve) or a throttle valve by which it is possible to regulate the coolant flow rate through the auxiliary radiator bypass line. Alternatively, the bypass valve may be a three way valve arranged at a branched portion between a line directing coolant to the auxiliary radiator and the auxiliary radiator bypass line.

According to an embodiment of the invention, the further object is a working medium cooled in a condenser in a WHR-system. In order to achieve a high thermal efficiency in a WHR-system, the working medium in the condenser is to be cooled to a condensation temperature as low as possible and substantially without subcooling. Consequently, in order to achieve a high thermal efficiency in a WHR-system, the working medium is to be cooled with a suitable cooling effect. However, the suitable cooling effect of the working medium in the condenser varies during different operating conditions such as with the heat effect supplied from, for example, the exhaust gases to the evaporator. Since the supplied heat from exhaust gases can vary rapidly, it is difficult to continuously provide a cooling effect of the working medium in the condenser resulting in a high thermal efficiency of a WHR-system. According to the invention, the first valve device, the second valve device and the bypass valve are controlled in a manner such that working medium is condensed in the condenser at a desired condensation temperature.

According to an embodiment of the invention, the further object is charge air cooled in a charge air cooler. Twin turbo installations are usually used to increase the power of a combustion engine by supplying charge air of a high pressure to the combustion engine. In a twin turbo installation, the charge air is compressed in a first stage by a low pressure compressor and in a second stage by a high pressure compressor. The amount of charge air which can be received and compressed in the compressors depends on the specific volume of the charge air. The charge air leaving the low pressure compressor has a raised pressure and a raised temperature. In order to reduce the specific volume of the charge air and increase the amount of charge air which can be received and compressed in the high pressure compressor, the charge air can be cooled in a charge air cooler arranged in a position between the compressors. The charge air leaving the high pressure compressor can be cooled in a further charge air cooler, for example, by air of ambient temperature in order to decrease the specific volume of the charge air and increase the amount of charge air which can be delivered to the combustion engine.

According to an embodiment of the invention, the auxiliary radiator is arranged in a position in the vehicle in which it is cooled by an air stream of a lower temperature than the temperature of the air stream through the main radiator. The main radiator is usually arranged behind a charge air cooler or another cooler at a front portion of a vehicle. Thus, the air stream through the main radiator usually has a higher temperature than the surrounding air temperature. The auxiliary radiator may be provided below, above or at one side of the main radiator where it is cooled by an air stream of surrounding air temperature.

According to an embodiment of the invention, the air stream through the auxiliary radiator is generated by a separate radiator fan. Such an auxiliary radiator fan may be independently controlled in relation to a main radiator fan forcing air through the main radiator. The auxiliary radiator fan may be driven by an electric motor. In this case, it is possible to control the cooling effect of the coolant in the auxiliary radiator in order to cool the further object to an efficient operating temperature. In order to reduce the consumption of electric energy, the auxiliary radiator is arranged in a position of the vehicle where it receives a cooling air stream by the ram air and the auxiliary radiator fan.

### BRIEF DESCRIPTION OF THE DRAWINGS

In the following preferred embodiments of the invention is described, as examples, with reference to the attached drawings, in which:

FIG. 1 shows a cooling system according to a first embodiment of the invention,

FIG. 2 shows a cooling system according to a second embodiment of the invention and

FIG. 3 shows a front view of the main radiator and the auxiliary radiator.

### DETAILED DESCRIPTION OF PREFERRED EMBODIMENTS OF THE INVENTION

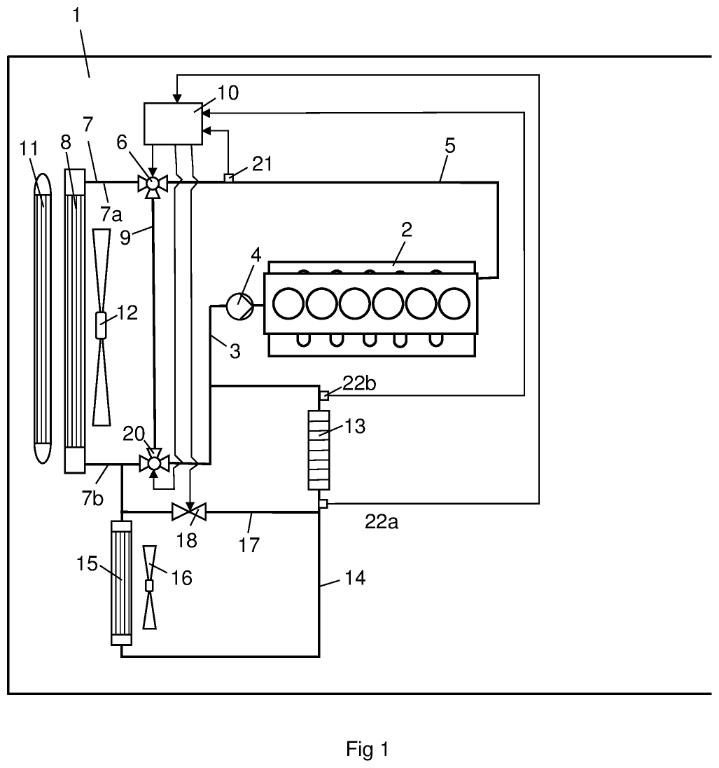

FIG. 1 shows a schematically disclosed vehicle 1 powered by a combustion engine 2. The vehicle 1 may be a heavy vehicle and the combustion engine 2 may be a diesel engine. The vehicle 1 comprises a cooling system comprising an engine inlet line 3 provided with a pump 4 circulating a coolant in the cooling system. The coolant is initially circulated through the combustion engine 2. The coolant leaving the combustion engine 2 is received in an engine outlet line 5. A first valve device in the form of a first three way valve 6 is arranged at an end of the engine outlet line 5. The first three way valve 6 has one inlet opening and two outlet openings. The cooling system comprises a main radiator line 7 directing coolant through a main radiator 8. The main radiator line 7 comprises a main radiator inlet line 7a, and a main radiator outlet line 7b. The cooling system comprises a main radiator bypass line 9 directing coolant past the main radiator 8. The first three way valve 6 is controlled by a control unit 10. The first three way valve 6 is adjustable in a stepless manner. Thus, it is possible for the first three way valve 6 to receive coolant from the engine outlet line 5 via the inlet opening and distribute a first part of it to the radiator line 7 via a first outlet opening and a second remaining part of it to the radiator bypass line 9 via a second outlet opening. In this case, a charge air cooler 11 is arranged in a position upstream of the main radiator 8. A radiator fan 12 and the ram air provide a cooling air stream through the charge air cooler 12 and the main radiator 8 during operation of the vehicle 1.

The cooling system is configured to cool at least one further object 13 than the combustion engine 2. The further object 13 is arranged in an auxiliary circuit 14 of the cooling system. The further object 13 is in this case exemplified as a working medium in a WHR system which is cooled in a condenser 13. The auxiliary circuit 14 comprises an auxiliary radiator 15 arranged upstream of the condenser 13 in view of the flow direction through the auxiliary circuit 14. The auxiliary radiator 15 is arranged in a position of the vehicle where the ram air and at least one auxiliary radiator fan 16 provides a cooling air stream through the auxiliary radiator 15. An auxiliary radiator bypass line 17 directs coolant past the auxiliary radiator 15. A bypass valve 18 controls the coolant flow through the bypass line 17. The bypass valve 18 is controlled by the control unit 10.

A second valve device in the form of a second three way valve 20 receives coolant from the radiator bypass line 9. The second three way valve 20 is controlled by the control unit 10. The second three way valve 20 is adjustable in a stepless manner. The second three way valve 20 has an inlet opening receiving coolant from the main radiator bypass line 9, an outlet opening directing coolant to the engine inlet line 3 and a third opening which may be an inlet opening or an outlet opening. The third opening may work as an inlet opening and receives coolant from the main radiator 8 and direct it to the engine inlet line 3. Alternatively, the third opening works as an outlet opening and directs coolant from the main radiator bypass line 9 to the auxiliary circuit 14. A first temperature sensor 21 senses the temperature of the coolant in the engine outlet line 5. Thus, the first temperature sensor 21 senses a temperature related to the temperature of the combustion engine 2. A second temperature sensor 22a senses the temperature of the coolant in the auxiliary circuit 14 in an upstream position of the condenser 13. A third temperature sensor 22b senses the temperature of the coolant in the auxiliary circuit 14 in a upstream position of the condenser 13. The third temperature sensor 22b senses a temperature related to the temperature of the working medium in the condenser 13.

During operation, the control unit 10 receives substantially continuously information from the temperature sensors 21, 22a, 22b about the actual coolant temperatures of the combustion engine 2 and the working medium in the condenser 13. The control unit 10 may also receive information about operating parameters of the WHR system. The control unit 10 may, for example, receive information about the actual condensation temperature in the condenser 13. The control unit 10 estimates a desired condensation temperature of the working medium in the condenser 13. When ethanol is used as the working medium, a condensation temperature of about 80° C. is desirable during most operating conditions. The control unit 10 estimates a required flow rate and a required temperature of the coolant flow to be directed to the condenser 13 in order to provide the desired condensation temperature in the condenser 13.

During operation, the control unit 10 receives substantially continuously information from the first temperature sensor 21 about the coolant temperature in the engine outlet line 5. In case the coolant temperature in the engine outlet line 5 indicates that the combustion engine 2 has a lower temperature than an efficient operating temperature, the combustion engine 2 does not need to be cooled. The control unit 10 adjusts the first three way valve 6 such that it directs a large part of the coolant flow to the radiator bypass line 9 and a remaining small part of the coolant flow to the radiator line 7. The second valve device 20 directs the coolant from the main radiator bypass line 9 to the combustion engine 2 without cooling. Due to this measure, the temperature of combustion engine will rise rapidly to an efficient operating temperature. The smaller part of the coolant flow is usually cooled in the main radiator 8 to a temperature low enough to cool the working medium in the condenser 13 to a suitable condensation temperature. In this case, it is not necessary to use the auxiliary radiator 15. Thus, the control unit 10 sets the bypass valve 18 in an open position such that the coolant is directed from the main radiator 8 to the condenser 13 via the auxiliary radiator bypass line 17. In case, the coolant has been cooled to a too low temperature in the main radiator 8, the second three way valve 20 is controlled such that it directs a suitable quantity of uncooled coolant from the main radiator bypass line 9 to the auxiliary circuit 14 where it is mixed with coolant from the main radiator 8. With a suitable mixture of said coolants of different temperatures, it is possible to direct coolant of a suitable temperature to the condenser 13, via the auxiliary radiator bypass line 17, at which the working medium is cooled in the condenser 13 to the desired condensation temperature.

In case the coolant temperature in the engine outlet line 5 indicates that the combustion engine 2 has a temperature within an efficient operating temperature range, the combustion engine 2 needs to be cooled in order to maintain this temperature. The control unit 10 adjusts the first three way valve 6 such that it directs a suitable part of the coolant flow to the radiator bypass line 9 and a remaining part of the coolant flow to the radiator line 7. The second valve device 20 directs a suitable mixture of coolant from the main radiator bypass line 9 and coolant from the main radiator 8 to the combustion engine 2. On one hand, the coolant flow in the main radiator 8 is cooled to a temperature low enough to cool the working medium in the condenser 13 to a suitable condensation temperature. In this case, it is not necessary to use the auxiliary radiator 15. Thus, the control unit 10 sets the bypass valve 18 in an open position such that the coolant is directed from the main radiator 8 to the condenser 13 via the auxiliary radiator bypass line 17. On the other hand, the coolant flow in the main radiator 8 is not cooled to a temperature low enough to cool the working medium in the condenser 13 to a suitable condensation temperature. In this case, it is necessary to use the auxiliary radiator 15. Thus, the control unit 10 sets the bypass valve 18 in a closed position such that the coolant is directed from the main radiator 8 to the condenser 13 via the auxiliary radiator 15.

In case the coolant temperature in the engine outlet line 5 indicates that the combustion engine 2 has a higher temperature than an efficient operating temperature range, the combustion engine 2 needs to be cooled in an optimal manner. The control unit 10 adjusts the first three way valve 6 such that it directs the entire coolant flow to the radiator line 7 and the main radiator 8. The second valve device 20 directs a suitable part of coolant from the main radiator 8 to the combustion engine 2. A remaining part of the coolant flow is directed to the auxiliary circuit 14. In case the coolant flow in the main radiator 8 has been cooled to a temperature low enough to cool the working medium in the condenser 13 to a suitable condensation temperature, the control unit 10 sets the bypass valve 18 in an open position such that the coolant is directed from the main radiator 8 to the condenser 13 via the auxiliary radiator bypass line 17. In case the coolant flow in the main radiator 8 is not cooled to a temperature low enough to cool the working medium in the condenser 13 to a suitable condensation temperature, the control unit 10 sets the bypass valve 18 in a closed position such that the coolant is directed from the main radiator 8 to the condenser 13 via the auxiliary radiator 15. Consequently, the cooling system is able to maintain an efficient operating temperature of a combustion engine 2 as well as a desired condensation temperature of the working medium in the condenser 13 during substantially all operating conditions.

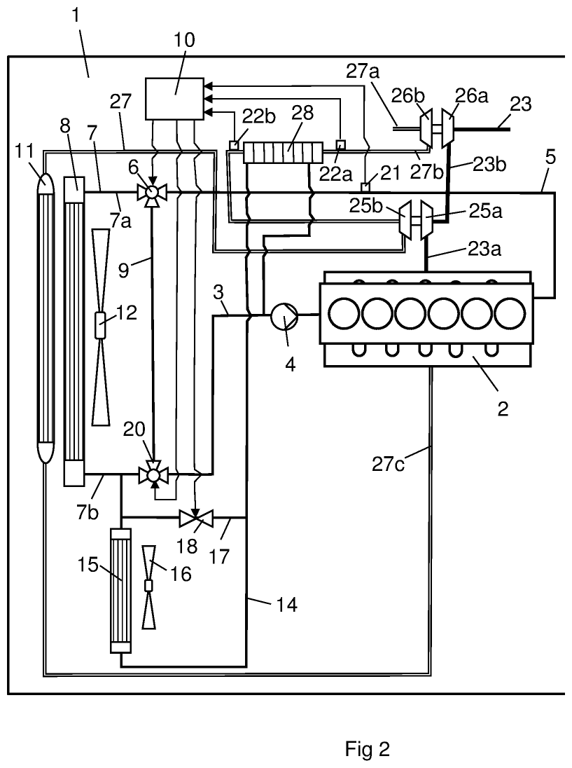

FIG. 2 shows an alternative embodiment of the cooling system. The exhaust gases from the cylinders of the diesel engine 2 are led via an exhaust manifold, to an exhaust line 23. The combustion engine 2 is provided with a high pressure turbo unit comprising a turbine 25a and a compressor 25b, and a low pressure turbo unit comprising a turbine 26a and a compressor 26b. The exhaust gases are initially led, via a first part 23a of an exhaust line 4, to the high pressure turbine 25a. The high pressure turbine 25a is thus provided with driving power which is transmitted, via a connection, to the high pressure compressor 25b. The exhaust gases are thereafter directed, via a second part 23b of the exhaust line 4, to the low pressure turbine 26a of the low pressure turbo unit. The low pressure turbine 26a is thus provided with driving power which is transmitted, via a connection, to the low pressure compressor 26b. The low pressure compressor 26b drawn air into an air inlet line 27. The air inlet line 27 comprises a first part 27a with air at ambient pressure. The air in the inlet line 27 is compressed in a first stage by the low pressure compressor 26b to a first charge pressure. The air inlet line 27 comprises a second part 27b located between the low pressure compressor 26b and the high pressure compressor 25b. The second part 27b of the air inlet line is provided with charged air at the first charge pressure. The charge air is cooled in a second part 27b of the air inlet line in an initial charge air cooler 28. The cooled charged air is compressed in a second stage in the high pressure compressor 25b. The air in the air inlet line 27 is cooled in a second stage in the charge air cooler 11 at the front portion of the vehicle 1 before it is directed, via a third part of the air inlet line 27c, to the combustion engine 2. The charge air may be cooled by air of ambient temperature at the front position of the vehicle 1.

During operation, the control unit 10 receives substantially continuously information from said temperature sensors 21, 22a, 22b about the actual coolant temperatures which indicates the temperature of the combustion engine 2 and the temperature of the charge air in the initial charge air cooler 28. The control unit 10 estimates the cooling demand of the charged air in the initial charge air cooler 28. The control unit 10 estimates a suitable coolant temperature and a suitable coolant flow rate to be directed to the initial charge air cooler 28 in order to provide the estimated cooling demand.

The temperature of the coolant in the engine outlet line 5 indicates the cooling demand of the combustion engine 2. In case the temperature of the coolant indicates that the combustion engine 2 has a lower temperature than an efficient operating temperature, the control unit 10 adjusts the first three way valve 6 such that it directs a relatively small part of the coolant flow to the radiator line 7 and a remaining large part of the coolant flow to the radiator bypass line 9. In this case, the second valve device 20 directs the coolant from the main radiator bypass line 9 to the combustion engine 2 without cooling. Due to this measure, the temperature of combustion engine will rise rapidly to an efficient operating temperature. The smaller part of the coolant flow is usually cooled in the main radiator 8 to temperature low enough to cool the charge air in the initial charge air cooler 28 to a suitable temperature.

In this case, it is not necessary to use the auxiliary radiator 15. Thus, the control unit 10 sets the bypass valve 18 in an open position such that the coolant is directed from the main radiator 8 to the initial charge air cooler 28 via the auxiliary radiator bypass line 17. In case, the coolant has been cooled to a too low temperature in the main radiator 8, the second three way valve 20 is controlled such that it directs a suitable quantity of uncooled coolant from the main radiator bypass line 9 to the auxiliary circuit 14 where it is mixed with coolant from the main radiator 8. With a suitable mixture of said coolants of different temperatures, it is possible to direct coolant of a suitable temperature to the initial charge air cooler 28, via the auxiliary radiator bypass line 17, at which the charge air in the initial charge air cooler 28 to a suitable temperature.

In case the coolant temperature in the engine outlet line 5 indicates that the combustion engine 2 has a temperature within an efficient operating temperature range, the combustion engine 2 needs to be cooled in order to maintain this temperature. The control unit 10 adjusts the first three way valve 6 such that it directs a suitable part of the coolant flow to the radiator bypass line 9 and a remaining part of the coolant flow to the radiator line 7. The second valve device 20 directs a suitable mixture of coolant from the main radiator bypass line 9 and coolant form the main radiator 8 to the combustion engine 2. On one hand, the coolant flow in the main radiator 8 is cooled to a temperature low enough to cool the charge air in the initial charge air cooler 28 to a suitable temperature. In this case, it is not necessary to use the auxiliary radiator 15. Thus, the control unit 10 sets the bypass valve 18 in an open position such that the coolant is directed from the main radiator 8 to the initial charge air cooler 28 via the auxiliary radiator bypass line 17. On the other hand, the coolant flow in the main radiator 8 is not cooled to a temperature low enough to cool the working medium in the condenser 13 to a suitable condensation temperature. In this case, it is necessary to use the auxiliary radiator 15. Thus, the control unit 10 sets the bypass valve 18 in a closed position such that the coolant is directed from the main radiator 8 to the initial charge air cooler 28 via the auxiliary radiator 15.

In case the coolant temperature in the engine outlet line 5 indicates that the combustion engine 2 has a higher temperature than an efficient operating temperature range, the combustion engine 2 needs to be cooled in an optimal manner. The control unit 10 adjusts the first three way valve 6 such that it directs the entire coolant flow to the radiator line 7 and the main radiator 8. The second valve device 20 directs a suitable part of coolant from the main radiator 8 to the combustion engine 2. A remaining part of the coolant flow is directed to the auxiliary circuit 14. In case the coolant flow in the main radiator 8 has been cooled to a temperature low enough to cool the charge air in the initial charge air cooler 28 to a suitable temperature, the control unit 10 sets the bypass valve 18 in an open position such that the coolant is directed from the main radiator 8 to the initial charge air cooler 28 via the auxiliary radiator bypass line 17. In case the coolant flow in the main radiator 8 is not cooled to a temperature low enough to cool the charge air in the initial charge air cooler 28 to a suitable temperature, the control unit 10 sets the bypass valve 18 in a closed position such that the coolant is directed from the main radiator 8 to the initial charge air cooler 28 via the auxiliary radiator 15. Consequently, the cooling system is able to maintain an efficient operating temperature of a combustion engine 2 as well as a desired temperature of the charge air in the initial charge air cooler 14 during substantially all operating conditions

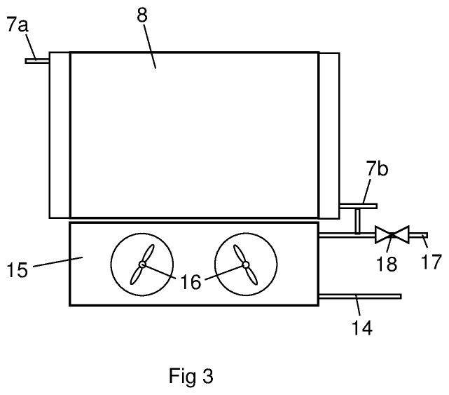

FIG. 3 shows a front view of the main radiator 8 and the auxiliary radiator 15. In this case, the auxiliary radiator 15 is arranged below the main radiator 8. Two auxiliary radiator fans 16 provides a cooling air stream through the auxiliary radiator 15. The auxiliary radiator fans 16 may be driven independently of the main radiator fan 12. Alternatively, the auxiliary radiator 15 may be arranged above or on a side of the main radiator 11. Preferably, the auxiliary radiator 15 is arranged in a position such that it receives a cooling air stream by the ram air and the auxiliary fan radiator fans 16 at the surrounding temperature. In this case, it is possible to cool the coolant to considerably lower temperature than in the main radiator 8.

The invention is not restricted to the described embodiment but may be varied freely within the scope of the claims.

1. A cooling system configured to cool a combustion engine and at least one further object in a vehicle, wherein the cooling system comprises:
a main radiator, a radiator line directing coolant through the main radiator;
a main radiator bypass line directing coolant past the main radiator;
a coolant line;
a first valve device receiving coolant from the coolant line and directing the coolant to the main radiator line and to the main radiator bypass line;
an auxiliary circuit directing coolant to the further object;
an engine inlet line directing coolant to the combustion engine;
a main radiator outlet line directing at least a part of the coolant leaving the main radiator to the auxiliary circuit; and
a second valve device in the form of a three way valve having an inlet opening receiving coolant from the main radiator bypass line;
an outlet opening from the second valve device directing coolant to the engine inlet line and a third opening of the second valve device which either may be an inlet opening receiving coolant from the main radiator and directing the coolant to the engine inlet line or may be an outlet opening directing coolant from the main radiator bypass line to the auxiliary circuit; and
the auxiliary circuit comprises an auxiliary radiator and an auxiliary radiator bypass line directing coolant past the auxiliary radiator which are arranged in an upstream position of the further object in the auxiliary circuit and an auxiliary radiator bypass valve configured to control the coolant flow through the auxiliary radiator bypass line.

2. A cooling system according to claim 1, further comprising a control unit configured to receive information about at least one operating parameter and to control the first valve device, the second valve device and the bypass valve in view of information about the at least one operating parameter.

3. A cooling system according to claim 2, further comprising one operating parameter related to the temperature of the combustion engine.

4. A cooling system according to claim 2, further comprising one operating parameter related to the temperature of the further object.

5. A cooling system according to claim 1, further comprising the first valve device is a three way valve.

6. A cooling system according to claim 1, further comprising at least one of the first valve device and the second valve device are configured to conduct smaller coolant flow rates with a higher accuracy than to conduct larger coolant flow rates.

7.

8. A cooling system according to claim 1, further comprising the auxiliary radiator bypass valve is a two way valve arranged in the auxiliary radiator bypass line.

9. A cooling system according to claim 1, further comprising the further object is a working medium cooled in a condenser in a WHR-system.

10. A cooling system according to claim 1, further comprising a charge air cooler in which the further object is charge air cooled.

11. A cooling system according to claim 1, further comprising the auxiliary radiator is arranged in a position in the vehicle in which the auxiliary radiator is cooled by an air stream of a lower temperature than the temperature of the air stream through the main radiator.

12. A cooling system according to claim 1, further comprising a separate radiator fan generating the air stream through the auxiliary radiator.
